(19) United States
(12) Patent Application Publication
(10) Pub. No.: US 2005/0273347 A1
(43) Pub. Date: Dec. 8, 2005

(54) Method and system for processing payment items at a central processor

(75) Inventors: Christopher A. Dudley, Louisville, KY (US); Carl Shishmanian, Louisville, KY (US); Arthur F. Guelda IV, Louisville, KY (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: Bank One, Delaware, National Association

(21) Appl. No.: 10/860,287

(22) Filed: Jun. 4, 2004

(51) Int. Cl. G06F 17/60

(52) U.S. Cl. 705/1; 705/39

(57) ABSTRACT

A method and system of the present invention are directed to processing payment items at a central processing facility for a merchant with multiple merchant locations. A computer implemented method for processing payment items may involve receiving an envelope with a label wherein the envelope comprises payment items from a merchant location; wherein the label indicates to a sorter at a mail facility that the envelope is destined for a central processor and the envelope skips regular mail channels; encoding one or more of the payment items at the central processor; depositing the payment items into a single national account associated with a merchant entity, wherein the merchant entity comprises a plurality of merchant locations; clearing the payment items through one or more payor entities; and providing funds availability information to the merchant entity through an online interface.

### FIELD OF THE INVENTION

The present invention relates generally to processing payment items (e.g., checks and other forms of payment), and more specifically to processing payments items, for a merchant with multiple merchant locations, at a Central Processor wherein the payments items are deposited in a single national account.

### BACKGROUND OF THE INVENTION

Many merchants maintain multiple store locations across a region, or even across the country. Such merchants may include retailers (e.g., clothing stores, furniture stores, mobile phone companies, specialty stores, etc.), service providers (e.g., investment companies, mortgage companies, etc.) and any entity that offers to sell a service or product to a consumer. Merchants may operate stores at various locations, including kiosks and other venues. In another example, merchants may also operate Internet websites, phone order services, mail order and/or other method for selling services and/or products. The traditional approach requires that the merchant take the checks to a local bank having a local merchant account each day. Branch locations will generally accept deposits until 2 or 3 in the afternoon, although most merchant locations operate for hours longer.

Thus, a merchant has many different local accounts across the country to deal with the various local points of receipt of payments from customers. Various banks may impose specific instructions and/or restrictions that may vary from other banks across the country. For a new merchant location, the merchant location would deposit funds at a local bank, which may impose new or different banking procedures.

The merchant then reconciles all of these various accounts that are maintained across the country. As various merchant locations use various different banks with varying banking procedures, the reconciliation process may take days or even longer. As a result, cash concentration is delayed thereby affecting investment, purchase and/or other decisions contingent on available funds. In addition, due to the reconciliation and other complexities, errors in accounting are more frequent.

Having multiple different accounts across the country and having to reconcile these various accounts is a significant drawback in terms of accounting complexity, costs, time and resources. Other drawbacks may also be present.

Accordingly, one aspect of the invention is to address one or more of the drawbacks set forth above.

In accordance with an exemplary embodiment of the present invention, a computer implemented method for processing payment items comprises the steps of receiving an envelope with a label wherein the envelope comprises payment items from a merchant location; wherein the label indicates to a sorter at a mail facility that the envelope is destined for a central processor and the envelope skips regular mail channels; encoding one or more of the payment items at the central processor; depositing the payment items into a single national account associated with a merchant entity, wherein the merchant entity comprises a plurality of merchant locations; clearing the payment items through one or more payor entities; and providing funds availability information to the merchant entity through an online interface.

In accordance with further aspects of this exemplary embodiment, the funds availability information is available at a time period less than 24 hours from a time when the merchant location transports the payment items in the envelope with the label; the payment items are collected at a merchant location during a time period within a single day; the method further comprises the step of providing report generating options through the online interface; the plurality of merchant locations are located throughout a plurality of states; the payment items comprise one or more of checks and cash; the funds availability information is sorted by a merchant location identifier assigned to each merchant location; the envelope is an envelope for overnight delivery; each merchant location of the merchant entity collects payment items where the payment items are transported from each merchant location to the central processor in the envelope.

In accordance with another exemplary embodiment of the present invention, a method for processing payment items comprises the steps of collecting payment items at a merchant location, wherein a merchant entity comprises a plurality of merchant locations; obtaining a label for an envelope to transport the payment items, wherein the label indicates to a sorter at a mail facility that the envelope is destined for a central processor and the envelope skips regular mail channels; transporting the payment items in the envelope with the label to the central processor wherein the payment items are deposited into a single national account and processed accordingly; and tracking one or more deposits associated with the payment items through an online interface.

In accordance with another exemplary embodiment of the present invention, a computer implemented system for processing payment items comprises receiving module for receiving an envelope with a label wherein the envelope comprises payment items from a merchant location; wherein the label indicates to a sorter at a mail facility that the envelope is destined for a central processor and the envelope skips regular mail channels; clear payment module for encoding one or more of the payment items at the central processor; depositing the payment items into a single national account associated with a merchant entity, wherein the merchant entity comprises a plurality of merchant locations; and clearing the payment items through one or more payor entities; and funds availability module for providing funds availability information to the merchant entity through an online interface.

### BRIEF DESCRIPTION OF THE DRAWINGS

FIG. 1 illustrates an exemplary system for processing payments, according to an embodiment of the present invention.

FIG. 2 illustrates an exemplary central processor for processing payments, according to an embodiment of the present invention.

FIG. 3 is an exemplary flowchart illustrating a method for processing payments, according to an embodiment of the present invention.

### DETAILED DESCRIPTION OF THE INVENTION

An embodiment of the present invention provides a single national depository service for check, cash deposits and/or other payments. Through an embodiment of the present invention, a single bank depository account may be used instead of many local accounts with disparate banking procedures thereby eliminating complicated reconciliation processes.

According to an embodiment of the present invention, local payments may be sent to a central processor after the payments are inserted in an envelope having a special encoding label that may include a unique location identifier. At a mail facility, the envelopes may be sorted based on the special encoding label. The envelopes may be handled by a mail service (e.g., UPS, etc.) earlier than normal mail delivery. According to an exemplary application, pick up or delivery may occur approximately 6 hours earlier than normal mail pick up or delivery. The packages may then be received at a central processor, e.g., financial institution hub. Once received at the central processor, the labels and payment items may be processed. The funds may be deposited to a single consolidated national account associated with the merchant. Therefore, while various merchant locations are located across a region, a single account may be used for deposits associated with the various merchant locations. Further, account summaries, funds availability information, various reports and/or other information may be available to the merchants and/or other authorized entities. According to an exemplary application, funds may be made available within the next day in the morning (e.g., at 10:30 am or other time).

An embodiment of the present invention may be implemented to handle cash, in which case the cash payments may be sent to a cash vault at a financial institution. Other payment instruments may be handled and processed accordingly.

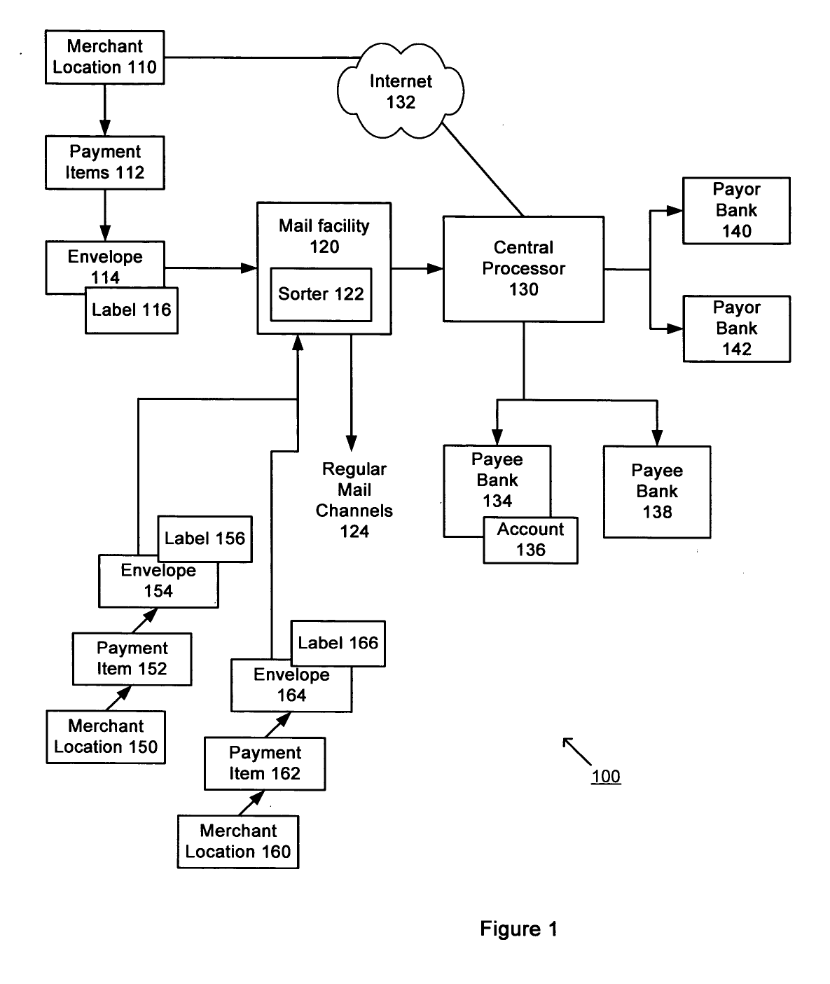

FIG. 1 illustrates an exemplary system for processing payments, according to an embodiment of the present invention. Each local merchant location may receive various checks and other types of payments throughout a business day (or other time period). Merchant Location 110 may represent various store locations including stores located at malls, buildings (or other location), kiosks, mail order facilities, phone order facilities, warehouses, and/or any location that receives payment items from consumers. At the end of the business day (or other time), each merchant location 110 may gather the checks and/or other payment items, as represented by Payment Items 112 and place the payment items in an Envelope 114, or other container or package. For example, the envelope may be an overnight envelope. A special label 116 may be obtained and affixed to the Envelope 114. The label 116 may include a unique location identifier and/or other data. The Envelope 114 may then be dropped off or picked up for delivery to a Central Processor 130.

In another example, the checks and/or payment items may be scanned and delivered directly to Central Processor 130 or an intermediary that will route the electronic payment items to the Central Processor 130. For example, payment items or payment data may be imaged and/or scanned where the electronic data may be transmitted electronically to Central Processor 130.

Multiple merchant locations may participate in an embodiment of the present invention. For example, merchant locations 150 and 160 may be located at different regions. Payments 152 from merchant location 150 may be gathered and placed in Envelope 154 with a special label 156. Similarly, merchant location 160 may gather payments 162 and place those payments in an envelope 164 with a special label 166. As illustrated by system 100, various merchant locations located across the country may send check payments and/or other payments to a single processing facility, e.g., Central Processor 130.

Envelopes may be received at a mail processing facility 120. Mail processing facility 120 may include a Sorter 122 for routing the envelopes with the special label as they are received. For example, Sorter 122 may route the envelopes for delivery to Central Processor 130. Other mail may be delivered to regular mail channels, as indicated by 124. Sorter 122 may route the envelopes electronically, manually or via pick up. According to an embodiment of the present invention, the envelopes may be routed to Central Processor 130 earlier than traditional pick up hours. According to an exemplary application, the envelopes may be received at Central Processor 130 approximately 6-8 hours earlier than traditional methods.

According to an embodiment of the present invention, a pre-established agreement may specify that the envelopes with the special label are outsourced earlier in the mail routine, where the envelopes with the special label are transported to Central Processor 130. Thus, the envelopes with the special label skip regular mail channels.

Central Processor 130 may serve as a single processing facility for various merchant locations, situated at different locations. Central Processor 130 may receive the envelopes and read (e.g., scan) the labels. The payment items located within the envelopes may be processed. For example, the payment items may be encoded and cleared through appropriate clearing channels. In addition, the MICR lines of check payments may be read and encoded into the payment item. Other processing procedures may be implemented. The payment items may be deposited into payee banks, as shown by 134, 138. For example, payment items may be deposited into a single national account (or any other specified account). One or more accounts, represented by 136, may be maintained at financial institution 134. The payment items may be debited from payor banks, as shown by 140, 142. The payment items may be transmitted to the banks at which the payment items are drawn upon. The payment items may be physically transported or images (or payment item data) may be transmitted electronically to the payor banks 140, 142. Other clearing procedures may be implemented.

According to an embodiment of the present invention, funds availability information may be available to the merchants in a more expedited manner. For example, funds availability data may be available the next morning. Each merchant location may examine deposits and/or other funds data based on store identifier and/or other filter or specific. As a single repository handles the payment items, reconciliation, returned payment items, and/or other procedures are simplified.

According to another embodiment of the present invention, merchants represented by merchant locations 110, 150, 160, may access Central Processor 130 through a communication medium, such as the Internet or other network. Merchants may view various types of data associated with the payment items, including tracking data, deposit data, funds availability, accounting reports, summary reports, etc. Further, a user name and password (or PIN) may be assigned to each user (e.g., merchant entity, merchant location, authorized agent, etc.) to ensure security and confidentiality.

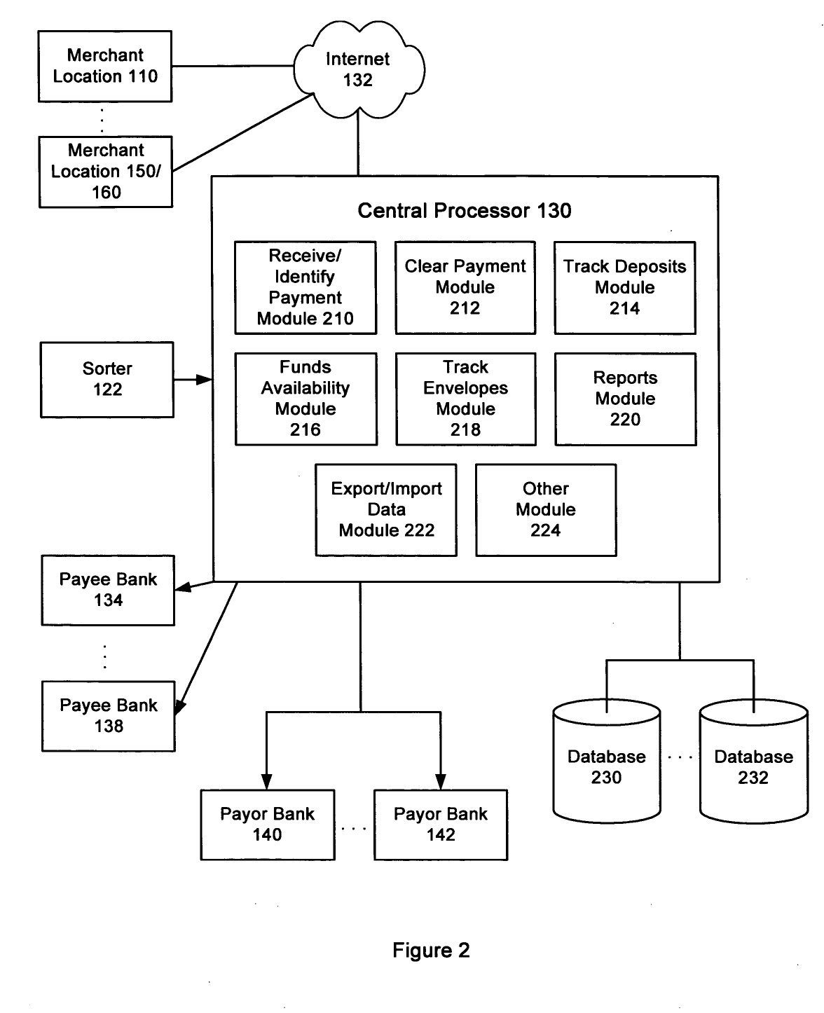

FIG. 2 illustrates an exemplary central processor for processing payments, according to an embodiment of the present invention. Central Processor 130 may include various modules for performing processing functions. For example, Central Processor 130 may include Receive/Identify Payment Module 210, Clear Payments Module 212, Track Deposits Module 214, Funds Availability Module 216, Track Envelopes Module 218, Reports Module 220, Export/Import Data Module 222 and/or other modules, represented by 224. The modules of Central Processor 130 may be further combined, duplicated and/or separated. The modules of Central Processor 130 may also be provided across multiple processors. Other implementations may be realized.

The various modules of Central Processor 130 may access and/or store data at Databases 230, 232. Various types of data may be stored at and/or accessed from databases 230, 232. Additional databases may be implemented. Further, the databases may be consolidated into a single database may be used as well. Database may include various types of databases, including relational databases. Database 230, 232 may store merchant data, including merchant identifiers, merchant locations, funds deposited, funds available, etc. Reports generated by Reports Module 220 may be stored in the databases as well. According to an exemplary application, return checks data may be stored in a database and accessed when processing suspicious payment items. Other data may be stored and/or accessed. Other sources of information (e.g., external and/or internal sources of data) may also be accessed by the various modules of Central Processor 130.

Merchant Locations 110, 150, 160 and/or other authorized entities may access information from Central Processor 130, via a communication medium, such as Internet 132 or other network. Central Processor 130 may be accessed by a merchant, including merchant entity, merchant locations and/or other authorized entity.

Central Processor 130 may receive the payment item from Sorter 122. Receive/Identify Payment Module 210 may receive payment items extracted from the envelopes. Depending on the type of payment item, different processing procedures may be applied. Clear Payment Module 212 may apply an appropriate processing procedure to clear the payment item. For example, for a check, the amount of the check may be encoded into the check. The payment item may be credited to a merchant account at payee bank (e.g., 134, 138) and sent to a payor bank (e.g., 140, 142) for debit/payment.

Track Deposits Module 214 may track of the various deposits made to a merchant. Funds Availability Module 216 maintains amounts of funds available to the merchant. Funds may be sorted by store, location and/or other filters.

Track Envelopes Module 218 may track the envelopes as they are in transit. For example, merchant locations 110, 150, 160, merchant entity and/or other authorized representative may access the Central Processor 130 to track the envelopes containing the payment items to ensure proper receipt.

Reports Module 220 may provide various reports to merchants based on merchant identified specifics. Reports may include summary reports, account reports, and/or other types of reports. Report Module 220 may provide merchants with access to current and prior day activity for balance reporting and/or other purposes. Reporting services provide the merchant with more control over funds and determine daily funding requirements. With this information, merchants may make investment, borrowing and/or other decisions more accurately and promptly. Reports may be provided by the merchant entity, as well as each merchant location or other authorized entity.

Export/Import Data Module 222 may enable a merchant to upload as well as download various data. Thus, manual data entry may be reduced and/or eliminated by automatically exporting data to spreadsheets and/or other account programs and tools.

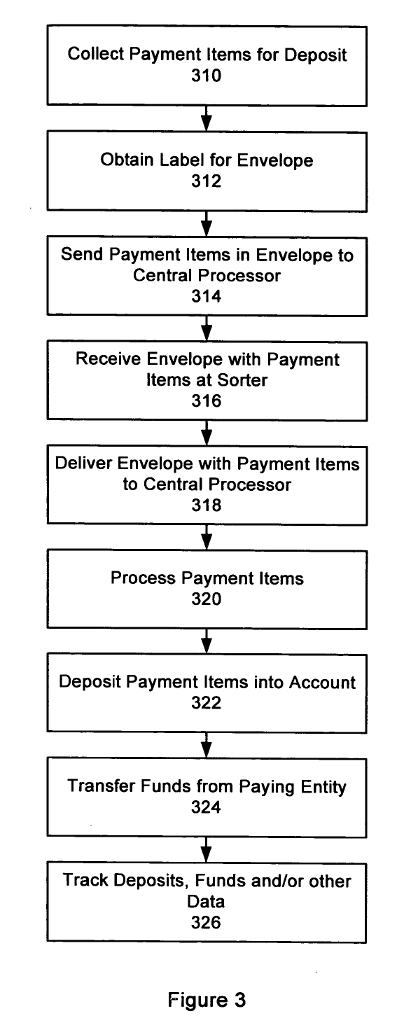

FIG. 3 is an exemplary flowchart illustrating a method for processing payments, according to an embodiment of the present invention. The method of an embodiment of the present invention provides simplified check processing and accelerated funds availability. At step 310, a merchant may collect payment items for deposit. At step 312, the merchant may obtain a special label. At step 314, the payment items may be sent in an envelope to a Central Processor. At step 316, envelope with the payment items may be received at a sorter. At step 318, the envelope with the payment items may be delivered to the Central Processor. At step 320, the payment items may be processed for clearance. At step 322, the payment items may be deposited into an appropriate account. At step 324, funds may be transferred from one or more paying entities. At step 326, the deposits and funds data may be tracked. While the process illustrated in FIG. 3 discloses certain steps performed in a particular order, it should be understood that the present invention may be practiced by adding one or more steps to the process, omitting steps within the process and/or altering the order in which one or more steps are performed.

At step 310, a merchant may collect payment items for deposit. For example, the merchant may represent a merchant at a specific location where payments may be collected throughout a time period (e.g., from opening to 6 p.m.). A merchant entity may include a plurality of merchant locations located throughout a region. Each merchant location may follow the procedure of an embodiment of the present invention for depositing payment items from each merchant location into a single designated account. In another example, multiple designated accounts may be used. For example, each region (or other identified area) may deposit payment items into a designed account.

Various types of payment items may be collected. Payment items may include checks, cash, cashier's checks, certified checks, and/or other forms of payment. As each merchant location receives payment items throughout a work day, those payments may be deposited for next day funds availability, through an embodiment of the present invention.

At step 312, each merchant location may obtain a special label for an envelope. The label may include an identifier, such as a bar code, symbol, code, etc., that will inform a sorter at a mail facility that the envelope will be delivered to a specified location. For example, the label may indicate to the sorter that the envelope will skip regular mail channels. In addition, the merchant may obtain the special label through a website or other user interface, where the merchant may input shipping information (e.g., shipping preference, shipping address, sender address, site identifier, deposit amount, description of items, etc.). For example, the merchant may identify the collective amount of payment items contained in each envelope, the time frame applicable to the collected payment items, a breakdown of type of payment items including amount for each type of payment item, as well as other data. Each merchant location may be assigned a specific merchant location code that may be built into the special label. Other identifying information may also be provided.

By obtaining a label for each envelope, the Central Processor may be informed that an envelope, identified by the label, should be received. In addition, a specific number of envelopes to be expected may be conveyed to the Central Processor. For example, a total number of envelopes to be expected from all participating merchants, each merchant entity and/or other data according to other specifics may be conveyed. Additional information may also be provided for tracking and/or reconciliation purposes. Other information may include sender information, merchant identifier, amount of payment items in a specific envelope, type of payment items, when to expect receipt of a specific envelope and/or other data. The information may be applicable for a specific merchant, merchant locations, plurality of merchant entities, all participating merchants, etc.

At step 314, the payment items may be sent in the envelope (or other package) to a Central Processor. For example, the merchant may simply drop off the envelope in a mail collection box or other mail facility (including merchant location affiliated with the mail facility), take the envelope to an authorized agent, schedule a pick up by a mail service at a pick-up time, etc. For example, the envelope may be delivered by a mail delivery service, such as UPS, FedEx™, etc.

At step 316, the envelope with the payment items may be received at a sorter. The sorter may be located at the mail facility. The sorter may read the label affixed to the envelope. The label indicates to the sorter that the envelope will skip regular mail channels and will be delivered to a specific location. As envelopes are received at the sorter, the envelopes may be collected for delivery or transport to the specific location.

At step 318, the envelopes with the payment items may be delivered to the Central Processor. Based on various pre-established agreements, the envelopes may be delivered to the Central Processor. In addition, a courier (e.g., driver, etc.) may pick up the envelopes at various intervals throughout the day (or at other time periods). While the envelope is in transit, the envelope may be tracked to ensure delivery and proper deposit.

At step 320, the payment items may be processed and cleared. As the envelopes are received at the Central Processor, the payment items may be extracted and processed accordingly.

At step 322, the payment items may be deposited into an appropriate account. For example, multiple merchant locations throughout a region may deposit payment items into a single designated account. An embodiment of the present invention may be directed to consolidating multiple accounts thereby reducing time and risk of making deposits. In another example, more than one designated account may be identified for a merchant entity. When the payment items are deposited, the funds may be made available to the merchant entity. Therefore, through an embodiment of the present invention, funds availability may be expedited.

At step 324, funds may be transferred from one or more paying entities. The payment items may be sent to the various paying entities (e.g., payor banks, etc.) for debiting procedures.

At step 326, the deposits and funds data may be tracked. The merchant or other authorized entity may access the Central Processor through a communication medium, such as the Internet, to track funds availability, deposits and other account activity. Deposits may be tracked by individual location and/or other identifier or specifics. In addition, reports may be generated, such as account reports, summary reports, etc. Returns, adjustments and/or other activity may be monitored and addressed appropriately.

As an embodiment of the present invention uses a single account (or consolidated accounts), return processes and/or other processes are simplified. For example, returned payment items may be processed by the Central Processor for consistency, rather than being processed by various disparate channels.

Various benefits may be realized by the embodiments of the present invention. Benefits may include a single demand deposit account (DDA) for depository services; individual location reporting and roll-up; reduction of idle balances and number of DDAs; streamlined depository procedures across client's network; simplified cash/treasury management reconcilement; more daily deposits by clients into the bank; reduced employee risk for making deposits at local depository; a tracking system from point-of-origin to destination; reduced risk of taking deposits to branches; earlier information reporting (e.g., 10:30 a.m. (ET)); contingency disaster recovery; and a full array of returns products, including Image, Represented Check Entry (RCK), and specialized reporting. Other benefits and advantages may be realized.

According to an embodiment of the invention, the systems and processes described in this invention may be implemented on any general or special purpose computational device, either as a standalone application or applications, or even across several general or special purpose computational devices connected over a network and as a group operating in a client-server mode. According to another embodiment of the invention, a computer-usable and writeable medium having a plurality of computer readable program code stored therein may be provided for practicing the process of the present invention. The process and system of the present invention may be implemented within a variety of operating systems, such as a Windows® operating system, various versions of a Unix-based operating system (e.g., a Hewlett Packard, a Red Hat, or a Linux version of a Unix-based operating system), or various versions of an AS/400-based operating system. For example, the computer-usable and writeable medium may be comprised of a CD ROM, a floppy disk, a hard disk, or any other computer-usable medium. One or more of the components of the system or systems embodying the present invention may comprise computer readable program code in the form of functional instructions stored in the computer-usable medium such that when the computer-usable medium is installed on the system or systems, those components cause the system to perform the functions described. The computer readable program code for the present invention may also be bundled with other computer readable program software. Also, only some of the components may be provided in computer-readable code.

Additionally, various entities and combinations of entities may employ a computer to implement the components performing the above-described functions. According to an embodiment of the invention, the computer may be a standard computer comprising an input device, an output device, a processor device, and a data storage device. According to other embodiments of the invention, various components may be computers in different departments within the same corporation or entity. Other computer configurations may also be used. According to another embodiment of the invention, various components may be separate entities such as corporations or limited liability companies. Other embodiments, in compliance with applicable laws and regulations, may also be used.

According to one specific embodiment of the present invention, the system may comprise components of a software system. The system may operate on a network and may be connected to other systems sharing a common database. Other hardware arrangements may also be provided.

Other embodiments, uses and advantages of the present invention will be apparent to those skilled in the art from consideration of the specification and practice of the invention disclosed herein. The specification and examples should be considered exemplary only. The intended scope of the invention is only limited by the claims appended hereto.

1. A computer implemented method for processing payment items, the computer implemented method comprising the steps of:
receiving an envelope with a label wherein the envelope comprises payment items from a merchant location; wherein the label indicates to a sorter at a mail facility that the envelope is destined for a central processor and the envelope skips regular mail channels;
encoding one or more of the payment items at the central processor;
depositing the payment items into a single national account associated with a merchant entity, wherein the merchant entity comprises a plurality of merchant locations;
clearing the payment items through one or more payor entities; and
providing funds availability information to the merchant entity through an online interface.

2. The method of claim 1, wherein the funds availability information is available at a time period less than 24 hours from a time when the merchant location transports the payment items in the envelope with the label.

3. The method of claim 1, wherein the payment items are collected at a merchant location during a time period within a single day.

4. The method of claim 1, providing report generating options through the online interface.

5. The method of claim 1, wherein the plurality of merchant locations are located throughout a plurality of states.

6. The method of claim 1, wherein the payment items comprise one or more of checks and cash.

7. The method of claim 1, wherein the funds availability information is sorted by a merchant location identifier assigned to each merchant location.

8. The method of claim 1, wherein the envelope is an envelope for overnight delivery.

9. The method of claim 1, wherein each merchant location of the merchant entity collects payment items where the payment items are transported from each merchant location to the central processor in the envelope.

10. A method for processing payment items, the method comprising the steps of: collecting payment items at a merchant location, wherein a merchant entity comprises a plurality of merchant locations;
obtaining a label for an envelope to transport the payment items, wherein the label indicates to a sorter at a mail facility that the envelope is destined for a central processor and the envelope skips regular mail channels;
transporting the payment items in the envelope with the label to the central processor wherein the payment items are deposited into a single national account and processed accordingly; and
tracking one or more deposits associated with the payment items through an online interface.

11. A computer implemented system for processing payment items, the computer implemented system comprises:
receiving module for receiving an envelope with a label wherein the envelope comprises payment items from a merchant location; wherein the label indicates to a sorter at a mail facility that the envelope is destined for a central processor and the envelope skips regular mail channels; clear payment module for encoding one or more of the payment items at the central processor; depositing the payment items into a single national account associated with a merchant entity, wherein the merchant entity comprises a plurality of merchant locations; and clearing the payment items through one or more payor entities; and
funds availability module for providing funds availability information to the merchant entity through an online interface.

12. The system of claim 11, wherein the funds availability information is available at a time period less than 24 hours from a time when the merchant location transports the payment items in the envelope with the label.

13. The system of claim 11, wherein the payment items are collected at a merchant location during a time period within a single day.

14. The system of claim 11, providing report generating options through the online interface.

15. The system of claim 11, wherein the plurality of merchant locations are located throughout a plurality of states.

16. The system of claim 11, wherein the payment items comprise one or more of checks and cash.

17. The system of claim 11, wherein the funds availability information is sorted by a merchant location identifier assigned to each merchant location.

18. The system of claim 11, wherein the envelope is an envelope for overnight delivery.

19. The system of claim 11, wherein each merchant location of the merchant entity collects payment items where the payment items are transported from each merchant location to the central processor in the envelope.

20. A system for processing payment items, the system comprising:
a collection means for collecting payment items at a merchant location, wherein a merchant entity comprises a plurality of merchant locations;
a label interface for obtaining a label for an envelope to transport the payment items, wherein the label indicates to a sorter at a mail facility that the envelope is destined for a central processor and the envelope skips regular mail channels; wherein the payment items are transported in the envelope with the label to the central processor wherein the payment items are deposited into a single national account and processed accordingly; and
an online interface for tracking one or more deposits associated with the payment items through an online interface.

21. At least one processor readable carrier for storing a computer program of instructions configured to be readable by at least one processor for instructing the at least one processor to execute a computer process for performing the method as recited in claim 1.

22. At least one signal embodied in at least one carrier wave for transmitting a computer program of instructions configured to be readable by at least one processor for processing payment items, the computer process comprising:
receiving means for receiving an envelope with a label wherein the envelope comprises payment items from a merchant location; wherein the label indicates to a sorter at a mail facility that the envelope is destined for a central processor and wherein the envelope skips regular mail channels; encoding means for encoding one or more of the payment items at the central processor;
depositing means for depositing the payment items into a single national account associated with a merchant entity, wherein the merchant entity comprises a plurality of merchant locations;
clearing means for clearing the payment items through one or more payor entities; and
funds availability means for providing funds availability information to the merchant entity through an online interface.
